(19) United States
(12) Patent Application Publication
(10) Pub. No.: US 2015/0029932 A1
(43) Pub. Date: Jan. 29, 2015

(54) Ultra broadband networks and methods

(71) Applicant: David A. Slemp, Duncans Mills, CA (US)

(72) Inventor: David A. Slemp, Duncans Mills, CA (US)

(21) Appl. No.: 14/120,983

(22) Filed: Jul. 16, 2014

Related U.S. Application Data
(60) Provisional application No. 61/958,091, filed on Jul. 18, 2013.

(51) Int. Cl. H04B 7/185; H04M 15/00

(52) U.S. Cl. CPC H04B 7/18506; H04M 15/61
USPC 370/316

(57) ABSTRACT

Broadband wireless data network systems and commercial methods for delivery of wireless communication services are described. The network systems utilize wavelengths in the E-band of the spectrum, and are mounted to aircraft. The aircraft based platform transmits communications data wirelessly at altitudes of 35,000 feet or greater, forms an airborne wireless mesh network nation-wide, and utilizes ground station network gateways to connect ground based communications and data devices.

### PRIORITY CLAIM

This application claims the benefit of the priority date of U.S. Provisional Patent Application No. 61/958,091 filed on Jul. 18, 2013, identifying inventor David A. Slemp; the contents of which are incorporated herein as if set forth in their entirety.

### FIELD OF THE INVENTION

The present invention relates to wireless data network systems and commercial methods for delivery of wireless communication services. In particular, the invention relates to a novel platform or platforms that form the backbone of the network for receipt and transmission of mobile wireless data within the network.

### BACKGROUND OF THE INVENTION

Universal high-capacity wireless coverage for mobile voice and data is the wireless communication industries' end goal. However, constraints on achieving this goal using current technology translate to decades of delay, if not rendering it completely impractical from a cost perspective, because the current system of cellular based communication systems requires continually expanding, upgrading, and maintaining a vast terrestrial network of short range transceiver base stations. This approach will be prohibitively costly and time consuming to achieve domestic universal coverage. An additional obstacle to universal coverage is the cost of providing backhaul. In the wireless communications industry, the term ‘backhaul’ (also known as ‘last mile’ or ‘last kilometer’) describes the final data link connecting the core network data paths to the wireless base station transceivers at the periphery. Most often these backhaul connections are dedicated wired telephone lines leased from the telephone company local to the base station site. However, many cellular base stations are located where telephone lines are not available. In this case the wireless network provider or the tower owner may install, for example, point-to-point microwave links to connect these remote base stations to the nearest telephone lines. Given these obstacles, there remains a need for a novel wireless communications platform in order to provide U.S. coast to coast coverage of next generation (‘5G’) wireless data and voice services.

Wireless data communications predominantly utilize wavelengths in the Ultra High Frequency or UHF (0.3-3.0 GHz) and Super High Frequency or SHF (3.0-30 GHz) spectrum bands, as regulated by the Federal Communications Commission (FCC). The FCC also recognizes the following bands: roughly 1-2 GHz as the L-Band; 2-4 GHz as the S-Band, and 4-8 GHz as the C band. Cellular communications within this portion of the spectrum generally use the UHF band which generally propagates without significant attenuation in the earth's lower atmosphere, or troposphere, via line of sight, from base station to the end user devices (such as, for example, wireless mobile phones and wireless modems). However, transmission of data is limited geographically by the lack of universal availability of cellular base stations within the line of site of an end user's mobile wireless device. Additionally, any number of obstructions, including hills, trees, buildings and mountains, exist between end user devices and base stations and can potentially disrupt the line of sight and therefore communication. The invention disclosed herein significantly overcomes the line of sight limitations and geographic constraints of traditional cellular wireless communications networks while drastically reducing the number of base station platforms required.

In the United States, wireless transmissions are permitted only within wavelengths designated by the FCC. In 2003, pursuant to FCC Report and Order FCC 03-248 released Nov. 4, 2003, the FCC made available for license 12.9 GHz of previously unavailable bandwidth for licensing to fixed terrestrial point to point microwave data links. Specifically, the newly available range is from 71-76, 81-86 and 92-95 GHz. This range in the spectrum is now collectively referred to as “E-band”. It is understood that some variations in the exact wavelengths referred to as E-band may be made by the FCC or other relevant governmental regulatory agency, and still be within the scope of the invention set forth herein. Further, use of the phrase “relevant governmental regulatory agency” herein is intended to refer to any entity in the United States or elsewhere that is given the authority to permit or deny access to utilization of portions of the spectrum for telecommunications. The newly available E-band represents an unprecedented amount of bandwidth and nearly 50 times the entire mobile wireless spectrum that was previously available.

Subsequent to release of FCC 03-248 (noted above), the FCC declared Jun. 21, 2004 as the start date for filing applications for non-exclusive nationwide licenses and Jul. 19, 2004 as the start date for licensees to register individual links under an interim link registration process. Consequently, as of 2004 E-band is open for fixed terrestrial point-to-point microwave data paths using a ‘light licensing’ model designed for rapid acceptance and installation. Commercial products are available now that provide 1 Gigabit per second (Gbps) full duplex data transfers, which is significantly more than the best traditional point-to-point microwave systems. However, it has already been demonstrated that 10 Gbps can be achieved within the same bandwidth without requiring extraordinary components or techniques. (See Chen, et al. “10 Gbps 16QAM Transmission over a 70/80 GHz (E-band) Radio Test-bed”, Proceedings of the 7^{th} European Microwave Integrated Circuits Conference, 30 Oct. 2012.)

E-band is unique for a number of reasons. For example, E-band lies in the part of the spectrum that has relatively low atmospheric attenuation properties (from water vapor, for example,) when compared to the rest of the millimeter spectrum (See FIGS. 1-3). E-band propagates well at high altitudes and especially at the Tropopause and above. This improved propagation is due to the low oxygen concentration (via low air pressure) and low water content, which is the largest contributor to E-band attenuation. The Tropopause is the boundary layer between the Troposphere and the Stratosphere. Most commercial aircraft fly in the lower Stratosphere to improve efficiency and to avoid bad weather. This altitude is just above the Tropopause. The Tropopause altitude varies depending on the latitude. At the poles the Tropopause is nominally at 9 km (30,000 feet). At the equator the Tropopause can be as high as 17 km (56,000 feet).

The graph of FIG. 1 shows the relationship of water vapor, in grams per cubic meter, to altitude in kilometers. This data is derived from the publication ‘U.S. Standard Atmosphere 1976’ (NASA, NOAA, US Air Force), using the mid-latitude mean reference data. At point 1 on the graph, water vapor concentration at sea level is approximately 5.7 g/m³. Line 2 on the graph represents 12 km (39,379 feet) altitude, the altitude at which many commercial aircraft fly. This line is nominally above the Tropopause. Water vapor concentration at 12 km altitude (point 3), is approximately 0.0035 g/m³. Therefore, at an altitude of 12 km, as compared to sea level, the water vapor concentration is reduced by a factor of 1,628:1, highlighting the dramatic decrease in potential attenuation properties at 12 km altitude.

The graph of FIG. 2 represents the decrease of atmospheric pressure that corresponds to an increase in altitude. Atmospheric pressure is used as a “proxy” here for oxygen density since the oxygen percentage stays relatively constant throughout the troposphere and lower stratosphere. In FIG. 2, line 4 represents the 12 km (39,379 feet) altitude line, the altitude at which most commercial aircraft fly. Point 5 represents atmospheric pressure at 12 km altitude, and is 0.185 atmospheres. Point 5 reflects that oxygen content is reduced to 18.5% of the oxygen content at sea level, another significant factor in decreasing attenuation properties.

FIG. 3 compares the attenuation of millimeter radio waves at sea level and at an altitude of 12 km, due to differences in oxygen concentration and water vapor concentration. Within ranges 6, two E-band sea level attenuation ranges are illustrated, one range for the mean annual global reference (the dashed line), and the other representing a worst case example of thick fog at sea level (the dotted and dashed line). Range 7 illustrates the mean global reference attenuation at 12 km altitude. The attenuation in the E-band ranges from 0.003 dB/km to 0.016 dB/km. For the same 200 km path, the total attenuation due to atmospherics ranges from 0.6 dB to 3.2 dB which is effectively without atmospheric attenuation. In these ideal atmospheric conditions, E-Band path loss will be dominated by simple antenna gain over distance. This antenna technology is very mature and is readily available now.

However, as it is used today, E-band is not well suited for communicating over very long distances. At sea level, high speed E-band data links can be made from 1 mile to 10 miles, depending on the predominant weather and acceptable error rate, using the commercial equipment now available. But E-band is especially well suited for high altitude use. If one were to take E-band equipment above 30,000 feet, the usable range increases to over 500 miles. This is due to the very low water vapor content, air density, and the absence of precipitation at these altitudes, as described above in relation to FIGS. 1-3. However, though there has been analysis of use E-band in relation to satellite communications, specifically to handle up and down links to satellite transmissions, (see “Link budget analysis for future E-band gigabit satellite communication links” (71-76 and 81-84 Ghz), U. J. Lewark et al., CEAS Space Journal, June 2013, Volume 4, Issue 1-4, pp 41-46; see also Antes, et al., MMIC-Based Chipset for Multi-Gigabit Satellite Links in E-Band, Wireless Information Technology and Systems, November 2012, pp 1-4, ISBN: 978-1-4673-0947-9), to date there has been no known use of E-band at such high altitudes, and no suggestion has been found to use E-band as the backbone of an airborne wireless communications network or airborne wireless mesh network.

Another unique and attractive feature of E-band is that at these short wavelengths, antennas can be made quite small. At these millimeter wave frequencies, the transmitted beams can be highly collimated into ‘spot’ or ‘pencil’ beams for low interference. A very high gain antenna array can be made smaller than two feet square and, using “patch” or Yagi antenna elements, can be laid flat, for low profile installations as compared with traditional parabolic dish antennas. In addition, as described by Val Dyadyuk et al in “Adaptive Antenna Arrays for Ad-Hoc Millimetre-Wave Wireless Communications,” means for employing multiple active steerable beams in E-band exist today and can be put to commercial use without much difficulty.

Given the potential advantages of E-band, and the maximization of these advantages at high altitudes, aircraft are a desirable platform for enabling use of E-band equipment. Mounting specialized equipment, such as flat antenna arrays, on multiple aircraft can create a plane to plane backbone network for transmission of communications. There are approximately 5,000 full size commercial jets in the US commercial fleet. There are approximately 1,000 additional regional aircraft and executive jets capable of service above 30,000 feet. At any given time, there are between 200 and 2,000 commercial airliners airborne over the lower 48 United States. (See www.planefinder.net). By using a portion of our nation's fleet of commercial aircraft as telecommunications platforms that can be directly connected with any mobile device within 100 miles or more, such a network can be created. This high aircraft density will generally provide at least four or more aircraft within range of any mobile device at any time. In densely populated areas, that number could be as high as 40.

It is an object of the invention to utilize existing aircraft traffic as a platform for equipment for transmitting communications data wirelessly via E-band, often at altitudes in excess of 35,000 feet. It is a further object of the invention to utilize the specially equipped aircraft to eliminate the need for a high bandwidth backhaul data network, yet provide backhaul services where needed for remote cellular network base stations. It is yet a further object of the invention to design commercial methods for implementing an ultra wide-band communications data network.

### BRIEF DESCRIPTION OF THE DRAWINGS

FIG. 1 is a graph illustrating the relationship between atmospheric water vapor concentration and altitude.

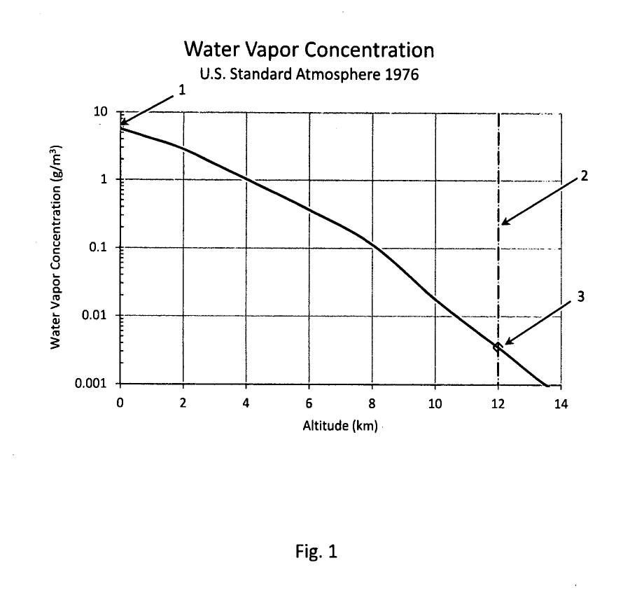

FIG. 2 is a graph illustrating the relationship between atmospheric pressure and altitude.

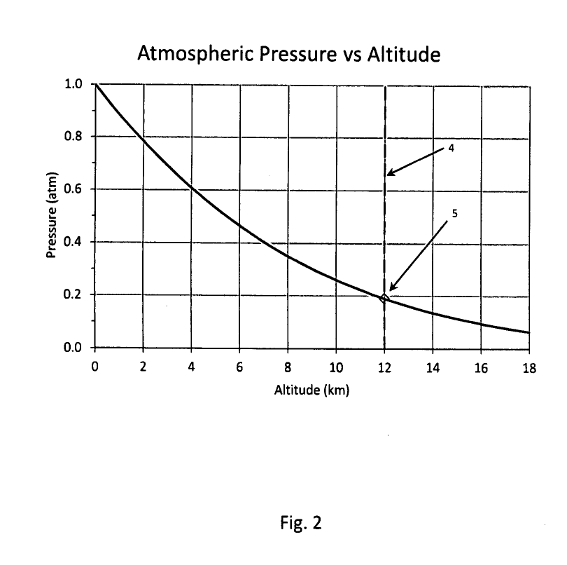

FIG. 3 is a graph illustrating specific attenuation of millimeter radio waves due to atmospheric water vapor and atmospheric pressure at sea level and at an altitude of 12 km.

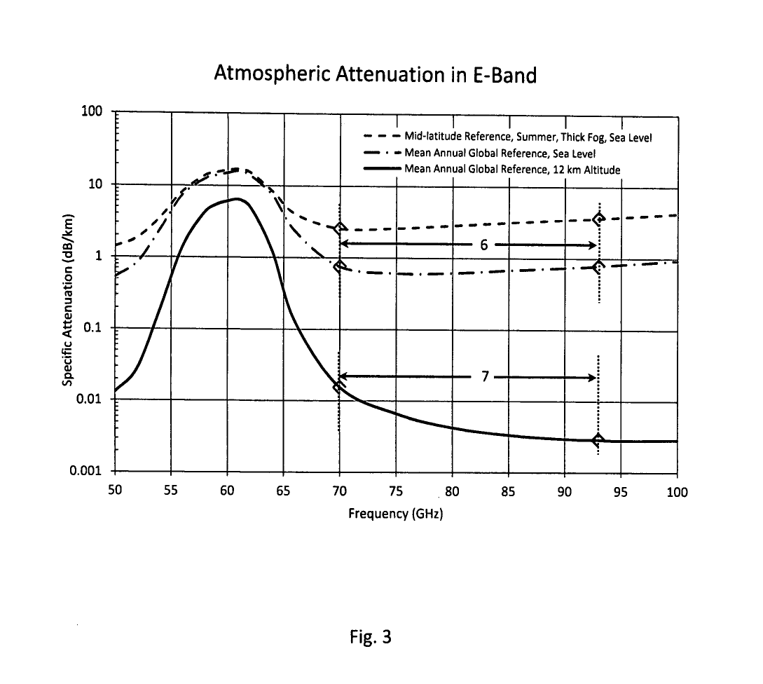

FIG. 4 is a conceptual illustration of a path of communications data according to the invention, from a first end user device to a second end user device.

FIG. 5 is also a conceptual illustration of a path of communications data according to the invention, using a wireless mesh network within a network and from a first end user device to a second end user device.

FIG. 6 is another conceptual illustration of an alternative path of communications data according to the invention, within a network and from a first end user device to a second end user device.

FIG. 7 is also a conceptual illustration of yet another alternative path of communications data according to the invention, from an end user device to a private network, to a terrestrial phone line, and to the World Wide Web.

FIG. 8 is a schematic illustration of a possible airborne transceiver system design for the airborne network.

FIG. 9 is a conceptual illustration of a plane to plane network according to the invention.

### DETAILED DESCRIPTION

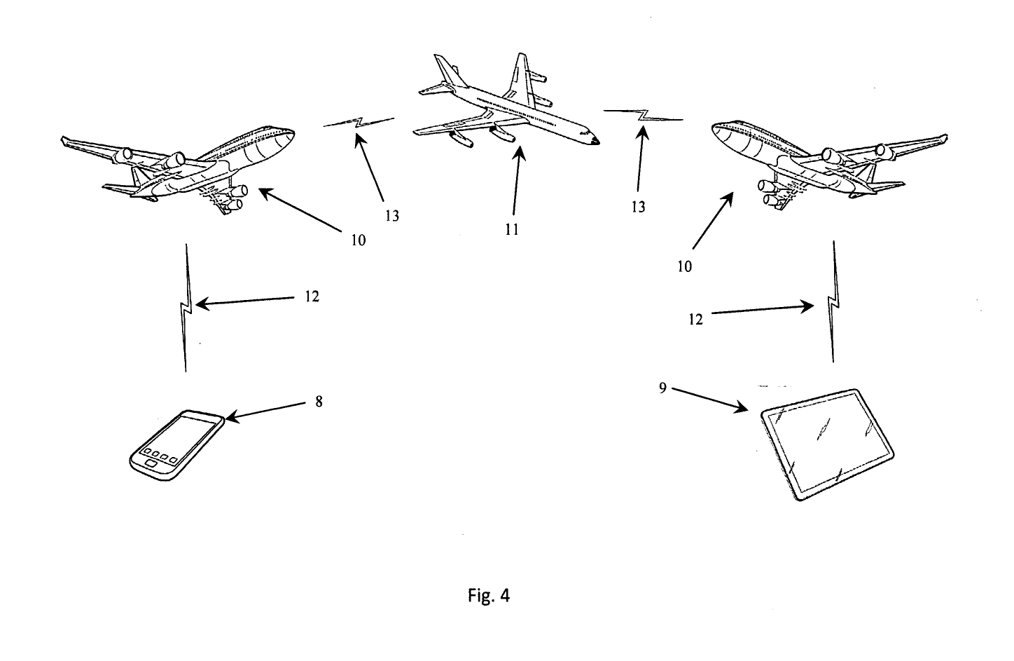

FIG. 4 illustrates an example of a simple communication path for voice or data between clients. In this example, a first client is using a first end user device, cellular telephone 8. The second end user is using a tablet 9. The communication path in FIG. 4 travels from cellular telephone 8 to tablet 9 through airborne base stations 10 utilizing L, S, or C-band, and via E-band 13 to and from intermediary data relays 11. In other words, beginning with cellular telephone 8, the communication path travels from cellular telephone 8, through L, S, or C band 12 to an airborne base station 10. It then travels from airborne base station 10 via E-band to intermediary data relay 11. The path travels from intermediary data relay 11 via E-band to an airborne base station 10 that is within range of tablet 9, where it arrives via L, S, or C band 12.

Though alternative numbers of data links and alternative configurations are within the scope of the invention, the plane to plane networking model considered here is one that will provide up to 8 simultaneous E-band data links on each side of the aircraft, for a total of 16 data links to 16 nearby equipped aircraft. Each data link may be capable of up to 10 Gbps in full duplex mode, which will provide a total capacity of 320 Gbps throughput per aircraft. During normal flight all E-band connections will be automated with many links dropped and added throughout every flight. This may require 16 radio beams created by adaptive antenna arrays that are steered remotely using known computer based technology. These plane to plane connections will automatically form a nation-wide Wireless Mesh Network (WMN) with 30 or more gateway access points co-located with the 30 busiest domestic airports for the high bandwidth terrestrial connections. Broadly speaking, a WMN is commonly known as a communications network that is formed of radio nodes that are organized in a mesh topology. WMNs are designed for autonomous traffic balancing and routing and are self-organizing. That is, WMNs form spontaneously, as wireless data travels among nodes until it finds its ultimate destination. WMNs are also highly redundant, and consequently are self-healing, because when a particular node becomes inoperable, wireless data will “find” an alternate path to an operable node and continue until it reaches its final destination. WMNs are therefore ideal for such a system.

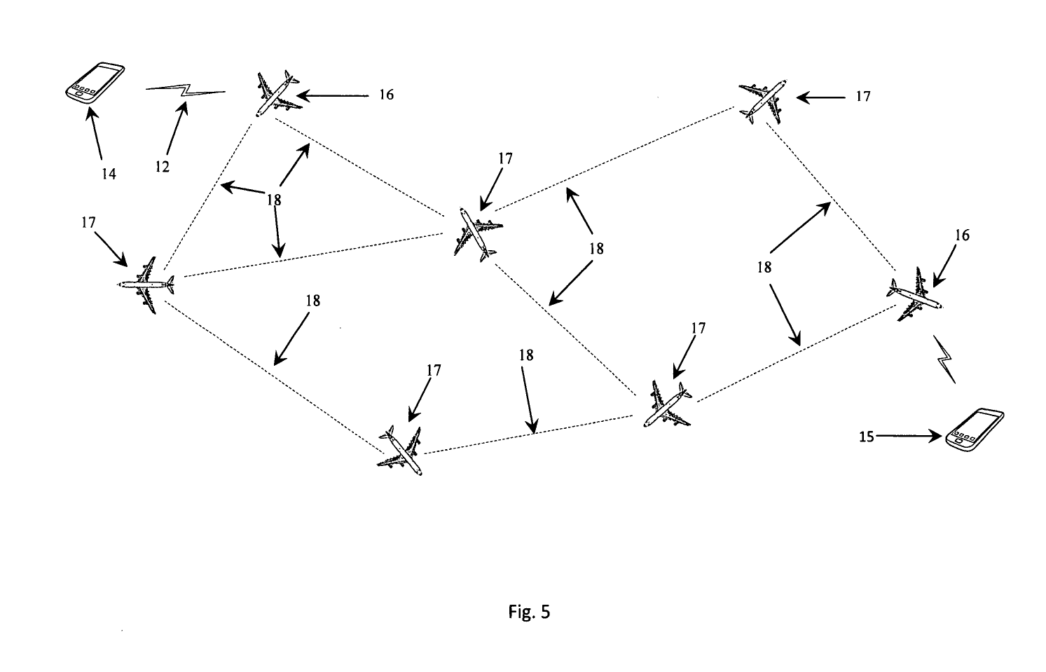

FIG. 5 illustrates a simple wireless mesh network used to create a communications link through multiple paths. In FIG. 5, a first end user device, cell phone 14, can communicate with a second end user device, cell phone 15, by connecting via L, S, or C band 12 to a first airborne base station, or aircraft 16. Once connected to aircraft 16, the data link can travel to any number of intermediary data relay aircraft 17, via E-band 18. As with a WMN as described above, as a particular intermediary data relay aircraft 17 becomes unavailable, wireless data will “find” an alternate intermediary data relay aircraft 17, and continue to its final destination, cell phone 15.

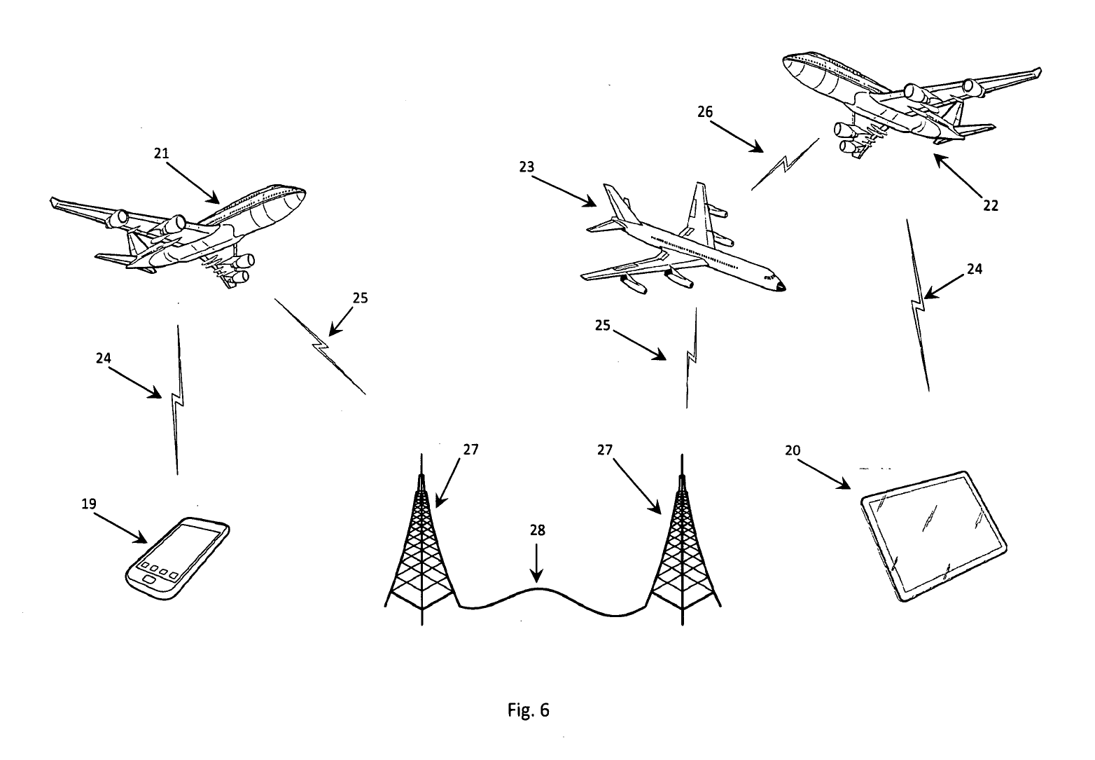

FIG. 6 illustrates an alternate communications path between end user devices. In FIG. 6, data is relayed from cell phone 19 to tablet 20. To connect the network and its subscribers to terrestrial networks and interne, the E-band traffic at 40,000 feet will need to be connected back down through the lower atmosphere to 30 or more ground station network gateways at very high data rates. Data travels from cell phone 19 to aircraft base station 21 via L, S, or C band 24. It then travels via L, S, C, or E-band 25, to ground station 27. Ground station 27 is equipped to connect the airborne network to a terrestrial network 28. From a ground station 27 that is connected to terrestrial network 28, the data then travels to an aircraft base station 23 via L, S, C, or E-band 25. Aircraft base station 23 can relay the data via E-band 26 to one or more aircraft 22 that are also part of the network of airborne base stations. Ultimately, an airborne base station relays the data via L, S, or C band to tablet 20.

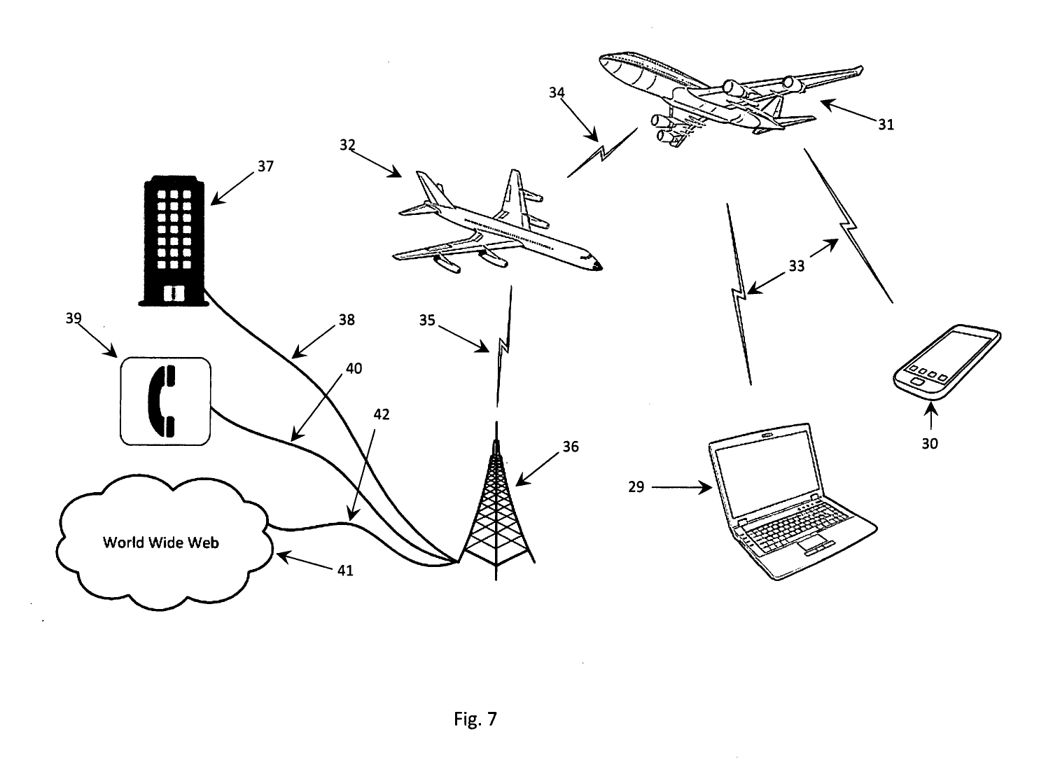

Turning now to FIG. 7, another alternative path of data transfer is illustrated. In FIG. 7, end user devices laptop computer 29 and cell phone 30 can communicate with remote networks and/or landline telephones via the path illustrated. Data from computer 29, and voice service from cell phone 30 can be relayed via L, S, or C band to an airborne base station aircraft 31. From aircraft 31, both data and voice service can be relayed via E-band to an alternate airborne base station aircraft 32. From aircraft 32, both data and voice can be relayed via L, S, C, or E-band to ground station tower 36, which has equipment connecting the airborne network to the terrestrial network. From ground station tower 36, data and voice can be relayed to a destination 37, via an actual or virtual private network 38. Voice and data can also be relayed to a telephone 39 via a standard terrestrial telephone line 40. In addition, voice and data can also be relayed to the World Wide Web via a terrestrial internet connection 42.

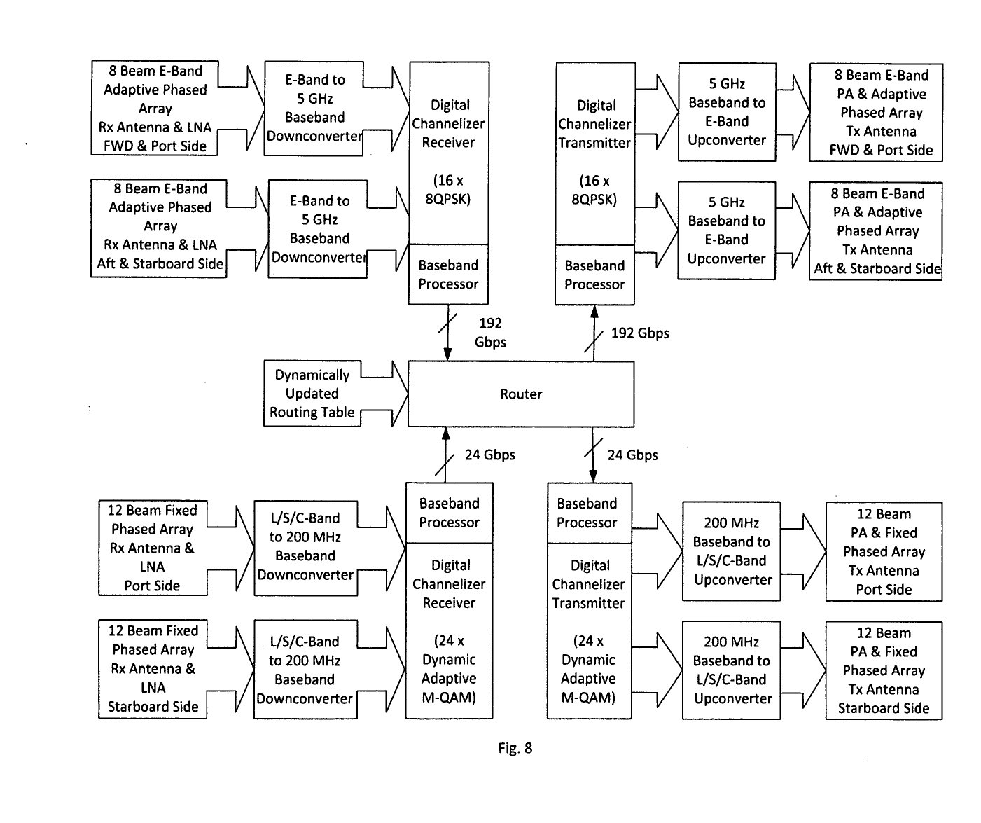

In order to achieve the communication paths described above in relation to FIGS. 4-7, the aircraft in each figure is equipped with specialized equipment. An example of the potential architecture for the airborne base station radio frequency equipment is illustrated in FIG. 8. The equipment includes a very high gain antenna array, using multiple dipole or patch antenna elements of two feet square and smaller, laid flat and mounted to the aircraft's fuselage or vertical stabilizer. Antenna arrays provide higher gain and can transmit longer distance with more elements. The term antenna is used herein to refer to any structure capable of receiving or transmitting wireless data via E-band. An individual antenna may be of any shape or size, though some shapes and sizes, such as the example set forth below, may confer significant advantages. An antenna array may be any number of antenna elements in any conceivable configuration, though some configurations may be more advantageous than others. It is assumed here that a square array will have a minimum of 64 elements per side (for a total of 1,024 elements), and may have as many as 128 (for a total of 16,384 elements.) It is likely that there may be a number of these antennas per aircraft to separate Transmit and Receive paths as well as the Lower E-band (71-76 GHz), Middle E-band (81-86 GHz) and Upper E-band (92-95 GHz). Additionally each of these may be divided further into Horizontal and Vertical polarizations to minimize interference. (See Table 1.) However, the best solution for interference will be high-gain pencil-beams so that signals transmitted will only illuminate the intended aircraft. This requires many elements in the array.

TABLE 1
E-band 16 antenna compliment per aircraft

| Antenna | Tx or | Upper, Middle | Horizontal or | Port or | N |
|---|---|---|---|---|---|
| Number | Rx | or Lower E-band | Vertical | Starboard | Beams |
| 1 | Tx | M | H | P | 2 |
| 2 | Tx | M | V | P | 2 |
| 3 | Tx | L | H | P | 2 |
| 4 | Tx | L | V | P | 2 |
| 5 | Tx | M | H | S | 2 |
| 6 | Tx | M | V | S | 2 |
| 7 | Tx | L | H | S | 2 |
| 8 | Tx | L | V | S | 2 |
| 9 | Rx | M | H | P | 2 |
| 10 | Rx | M | V | P | 2 |
| 11 | Rx | L | H | P | 2 |
| 12 | Rx | L | V | P | 2 |
| 13 | Rx | M | H | S | 2 |
| 14 | Rx | M | V | S | 2 |
| 15 | Rx | L | H | S | 2 |
| 16 | Rx | L | V | S | 2 |

While Table 1 shows 16 antennas to be mounted for E-band, some of these antennas may be combined or co-located. For example, it is possible that the Horizontal and Vertical polarization antennas of the same type may be mounted in the same footprint. Or, it may be possible for a single antenna to handle both Upper and Lower E-bands and 4 beams. In any event, these will be small antennas that may be less than a foot square each. They will be mounted flush on the aircraft either on the fuselage or on the sides of the vertical stabilizer. It's also possible that all antennas per side could be mounted in a single module that might be 1 ft.×8 ft. in dimensions or less. The only cable connections would be power and fiber-optic lines which should make installation relatively simple.

While the 16 antennas mentioned above will cover most of the at-altitude traffic, additional E-band antennas will need to be added to provide nose to tail links that can provide enough bandwidth to handle gateway traffic on take-off or approach. This may require four to eight more adaptive array antennas.

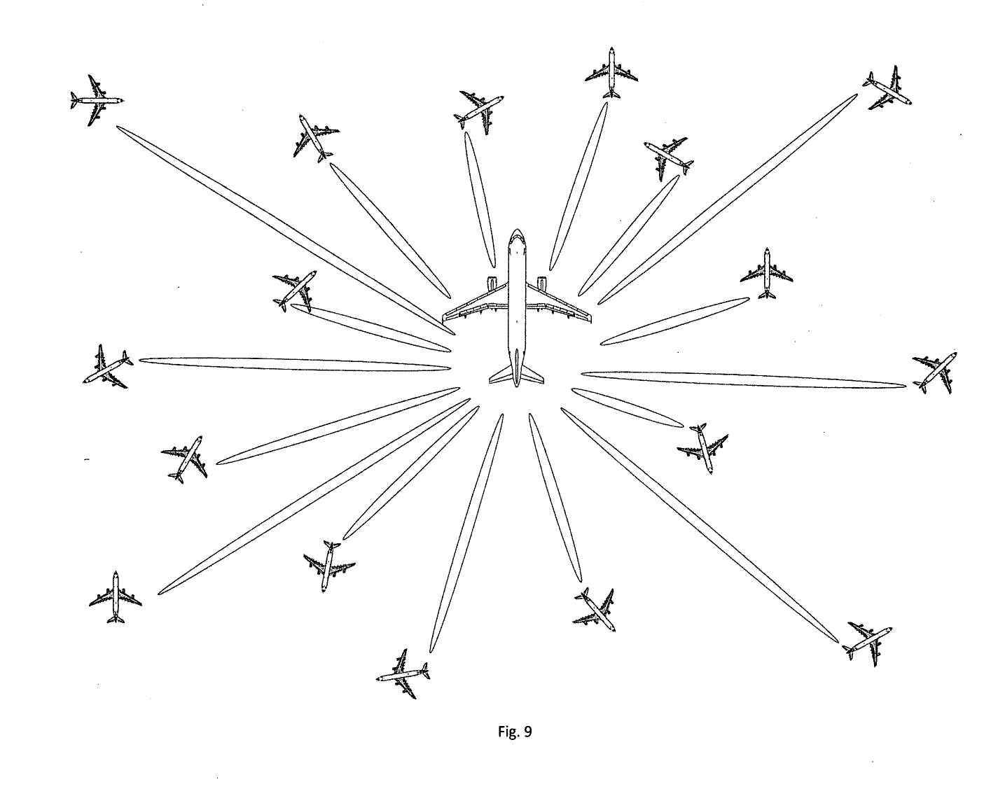

E-band systems with multiple beams and simultaneous transfers will be the backbone of a system according to the invention. An illustration of 16 simultaneous steered E-band connections via 16 airborne aircraft is depicted in FIG. 9. The capacity of such a system will approach terrestrial fiber-optic networks with multiple terabits per second (Tbps) total through put capacity.

To connect the network and its subscribers to terrestrial networks and internet, the E-band traffic at 40,000 feet will need to be connected back down through the lower atmosphere to 30 or more ground station network gateways at very high data rates. The weather, water vapor, and air density of the lower atmosphere make E-band communications much more difficult. While some locations, such as those in the dry Southwest, may allow E-band to carry traffic to the ground, other locations may be more problematic. In locations having significant annual precipitation and fog and high humidity, E-band may be limited to just a few kilometers or less. According to the invention there are a number of strategies, that together or separately, will overcome the challenges of passing the communications through these atmospheric gateways.

Examples of some of these strategies include very high gain E-band ground antennas, possibly built in an array and having many thousands of elements to provide much greater effective radiated power and sensitivity, and therefore greater range. Such an antenna array will very likely be part of a gateway downlink system. An additional example is high elevation E-band ground stations. The thickest part of our atmosphere also contains the most water vapor, which is concentrated at sea level. To minimize this attenuating layer, selecting installation locations at higher altitudes will greatly improve the ability to connect to the airborne mesh network. Doing so will concentrate many ground stations to the western half of the US and, to a lesser extent, the mountain ranges in the East. This example is very likely to be part of such a system.

An additional example is concentrating E-band ground stations in drier climates. Since water vapor and precipitation will attenuate E-band signals and reduce useful range, placing downlink gateway stations in dry climates is a logical countermeasure to minimize this attenuation. This strategy will concentrate a high number of gateways in the desert southwest, and is very likely to be a part of the system.

Yet another example is using lower altitude airborne relays. Using a number of dedicated manned or unmanned aircraft equipped with equipment according to the invention, it will be possible to have a dedicated relay layer at 10,000 or 20,000 feet above a gateway ground station. These aircraft could circle the gateway at constant altitude perpetually, relaying data from the high altitude network to the ground station, and is likely to be a part of a system according to the invention.

Still another example is Laser Communications (Lasercomm). There are many efforts to advance laser technology for communications for spacecraft to spacecraft, satellites to ground, and even satellites to submarines. While optical communications deal with many of the same atmospheric problems as E-band, this technology is quickly gaining ground.

Still further, according to a commercial method of the invention, pricing can bias connections directly through the system. Incentives to the wireless industry to invest more heavily and consistently in a system according to the invention may be useful in implementing the commercial methods. And finally, added mobile frequency connections to existing towers may allow some of the downlink traffic to be routed to towers for reducing the gateway traffic whenever possible.

These are only a few of many examples of ways to create reliable downlink gateways. Future studies will expand on these and many others that are within the scope of the invention.

The end user wireless connection is the most important in terms of availability, reliability and bandwidth. Terrestrial mobile networks have used the cellular network model for decades and it is ideal for maximum spectral efficiency, low interference, and frequency reuse. However, the cellular model requires that the network nodes be fixed in position and beam direction. With moving aircraft as telecomm platforms, a purely cellular model is impossible and therefore a different model must be used. The following is a list of examples of new characteristics.
1. Airborne platforms and their connected mobile devices must operate in a different environment than standard cellular networks. A system according to the invention may have to include features to account for: Moving radio beams—There will likely be multiple spot beams radiated from each aircraft to the ground and so a mobile device will undergo a constant series of hand-off processes from beam to beam and from aircraft to aircraft. Strategies known in the art which are currently utilized by satellite wireless network providers will address this issue. (See Debabrata Sarddar et al., “A Handover Management in LEO Satellite Network using Angular and Distance Based Algorithm, International Journal of Computer Applications (0975-8887) Volume 31-No. 5, October 2011.)
2. Beam interference—The spot beams on each aircraft will be designed with overlap and multiple aircraft will routinely cover the same areas with their beams using the same frequencies. A system according to the invention may incorporate embedded coding, known as Spread Spectrum, and currently utilized in conventional wireless networks, in order to operate in an interfering environment.
3. Doppler shift—Airborne platforms will be travelling at nearly 600 miles per hour. This will induce a considerable Doppler shift in front and behind the aircraft. The airborne platforms and mobile devices will need to compensate for this frequency shift, especially to make best use of the spectrum without unnecessarily large and wasteful guard bands. However, satellites also encounter a Doppler shift. A system according to the invention may incorporate a strategy to overcome this issue that is similar to one currently used for satellite wireless networks.
4. Pronounced Near-Far problem—As in traditional Code-Division Multiple Access (CDMA), the SkyNet user link will have to contend with variable power levels due to varying distances between mobile devices and the aircraft. In this case, that distance difference can be over 100 miles which will present much greater power differences than encountered in terrestrial networks. A system according to the invention may increase the number of spot beams of a system in order to reduce the problem. In addition, satellites currently encounter Near-Far problems that extend for thousands of miles. A system according to the invention may also adopt techniques similar to those used for satellite wireless systems in order to reduce the problem.
5. Much higher connection densities—A single aircraft will cover the same area as hundreds of terrestrial cellular towers. That means that an aircraft platform will need to be able to simultaneously handle thousands of voice and data connections. This will be modeled more like a satellite phone system than cellular phone system in order to address this issue.
6. Much higher data transfer rates—The goal for user service is to provide peak download speeds of 1000 Mbps or more. This 5G level of data speeds coupled with higher call densities will present a challenge from an equipment, modulation and spectrum perspective, but it can generally be resolved if sufficient bandwidth and multiple channels per user device are provided. In other words, if download speeds are unsatisfactory, then added antennas and transceivers to the same device can increase download capacity. This technique is commonly known as Multiple Input/Multiple Output, or MIMO.

As many of the above examples illustrate, satellite phone technology has a similar set of operating conditions. The satellites are moving at high speed relative to the user devices therefore there are handoffs between platforms and Doppler shift issues that needed to be overcome. The number of user connections per platform also run into the thousands and the near-far problem can cover an entire continent. The biggest differences between the invention and satellite telephony are the propagation delay (much higher for satellite), the user bandwidth availability (much higher for a system according to the invention), and the number of operational platforms (in the thousands for the system, dozens for satellite).

While there are a number of modulation strategies that would likely be acceptable to provide the user air interface, whatever is ultimately designed will look more like a satellite network rather than a terrestrial cellular network.

A possible air interface design according to the invention might consist of:
1. A hybrid multiple access scheme (FDMA/CDMA, or FDMA/TDMA)
2. Spatial isolation in the form of multiple spot beams with independent transceivers (SDMA)
3. Agile 256-QAM digital modulation scheme (as used herein, agile connotes that the scheme can be 256, 128, 64, 32, 16, or 8-QAM).
4. 200 MHz or more of dedicated usable mobile bandwidth nationwide (will require changes to US Frequency Allocations)
5. Multiple Input/Multiple Output (MIMO) transceivers at user device

For example, each aircraft may have 24 spot beams with each beam servicing one or more frequency subsets (perhaps 20 MHz each) of the available frequency spectrum. Up to 256-Quadrature Amplitude Modulation would be used for the actual RF digital data. Within each beam's frequency band, multiple users would connect via direct sequence code division multiple access (DS-CDMA). User devices would be able to connect via multiple codes and multiple frequencies to scale up or down user bandwidth as required.

All of the techniques mentioned above are in use today and would not be considered risky if implemented in a system according to the invention. RF densities using 256-QAM have been shown to achieve over 7 bits/s/Hz commercially. Therefore, 20 MHz of RF bandwidth can transmit over 140 Mbps, and 200 MHz of RF can transmit over 1.4 Gbps. 4G-LTE cellular has a spectral efficiency of over 16 bits/s/Hz which might translate to over 3.2 Gbps for 200 MHz bandwidth if used for a system according to the invention. Using spatial diversity, a single aircraft platform may be able to achieve 20 Gbps or more user bandwidth.

Providing 5G level user performance will require significant additional mobile bandwidth that is not yet allocated in a form usable by the invention. Terrestrial networks will also require additional bandwidth for their 5G service, so the FCC will be opening up new spectrum in the future. In 2010 President Obama ordered the FCC to allocate an additional 500 MHz of bandwidth for mobile services by 2020, and they have successfully allocated over 200 MHz to date. This indicates an optimal regulatory environment for a system according to the invention as it requests the necessary bandwidth to be successful.

As an alternative path that may minimize possible regulatory hurdles, deployment of the IEEE 802.16 standard, known as the Wireless Interoperability for Microwave Access, or “WiMax” as a Plane to Ground (user device) link will be considered. WiMax gear installed in aircraft, whether commercial airliners, dedicated aircraft, or other aircraft, is a means for bringing the High Altitude Platform (HAP) service from the airborne network to terrestrial devices and/or networks.

Numerous terms are used herein that are commonly known in the art. Some are defined herein to provide understanding of the invention. Moreover, specific embodiments of the invention, descriptions and drawings thereof are provided herein in order to explain the features of the invention. The invention herein is susceptible to modifications and alternative embodiments. It will be understood that the invention claimed is not limited by the specific embodiments described herein. The claims cover all equivalents and modifications that fall within the spirit and the scope of the invention.

I claim:

1. An ultra-broadband wireless system for transmitting and receiving data comprising a network backbone that utilizes the E-band of the radiofrequency spectrum at an altitude of between 5,000 feet and 120,000 feet, the system including at least two aircraft disposed at an altitude of between 5,000 feet and 120,000 feet and a first end user device, the aircraft comprising telecommunications equipment disposed thereon, wherein the telecommunications equipment of each aircraft is enabled to transmit data to and to receive data from each of the other aircraft utilizing the E-band, and the first end user device comprises features enabled to transmit data to and to receive data from each of the aircraft.

2. The system according to claim 1 further comprising at least one high bandwidth ground station comprising elements enabled to transmit data to and to receive data from the aircraft and to transmit data to and receive data from a terrestrial network and to either a second end user device or to the internet.

3. The system according to claim 1 wherein the telecommunications equipment comprises WiMax standard equipment.

4. The system according to claim 2 further comprising a plurality of downlink gateways disposed in a plurality of geographic regions having dry climates or high elevation or both.

5. The system according to claim 1, wherein said telecommunications equipment includes at least one antenna array for receiving and transmitting data utilizing E-Band, and said aircraft include an aircraft body, one or more wings and one or more stabilizer components, and said antenna array is disposed on at least one of the aircraft body, wings, or stabilizer components.

6. The system according to claim 1, further comprising a third aircraft and at least one high bandwidth ground station, the third aircraft disposed continuously at altitude of between 5,000 feet and 30,000 feet, wherein the third aircraft comprises telecommunications equipment enabled to receive and transmit data from E-band to the at least one high bandwidth ground station, whereby signals are relayed from the two aircraft to and from the third aircraft and to and from the at least one high bandwidth ground station.

7. The system according to claim 1, further comprising a link between an aircraft and a ground based station, wherein said link utilizes laser communications capabilities.

8. The system according to claim 1, wherein the telecommunications equipment comprises a hybrid multiple access scheme including an agile Quadrature Amplitude Modulation (QAM) digital modulation scheme.

9. The system according to claim 1, wherein the equipment comprises multiple spot beams with functionally independent transceivers.

10. The system according to claim 1 wherein the system further comprises between 1 and 500 MHz or more of dedicated usable bandwidth nationwide from at least one of the aircraft to the first end user device.

11. The system according to claim 1 wherein the first end user device comprises multiple input/multiple output antennas, transceivers, or both.

12. The system according to claim 1 further comprising a downlink capable of backhauling excess capacity for data traffic to a terrestrial network via mobile communications frequencies of 10 GHz or less whereby said system provides backhaul services to remote cellular network ground base stations.

13. The system according to claim 1 further comprising at least three aircraft, wherein said system forms a wireless mesh network.

14. A method of providing wireless mobile data services, the method comprising the steps of:
obtaining permission from the appropriate regulatory agency to steerably transmit data via E-band at altitude of up to and including the earth's stratosphere, and to transmit lower frequency spectrum data from mobile airborne platforms to either other mobile platforms or to fixed terrestrial devices;
obtaining permission from the appropriate regulatory agency to utilize bandwidth in the range of 0.1 GHz to 10 GHz frequencies;
providing telecommunications equipment including airborne network communications equipment capable of transmitting and receiving data via E band;
disposing the equipment on a plurality of aircraft;
disposing compatible equipment on end user devices; and
charging a fee for use of the services.

15. The method according to claim 14, wherein the equipment comprises a first antenna system for receiving and transmitting data utilizing the E-Band, and a second antenna system that enables mobile data connections, wherein said first and second antenna systems are disposed on at least one of the body, wings, or stabilizers of the plurality of aircraft.

16. The method according to claim 14, wherein the equipment comprises multiple spot beams with functionally independent transceivers.

17. The method according to claim 14 wherein the equipment establishes a system comprising 5-MHz or more of dedicated usable bandwidth nationwide.

18. The method according to claim 14, wherein the step of disposing the equipment on a plurality of aircraft further includes at least one of the following steps: entering a suitable business agreement with one or more commercial air carriers and installing the equipment on one or more commercial aircraft; leasing or buying independent aircraft and installing the equipment on one or more of the aircraft.

19. The method according to claim 14, wherein the steps of providing telecommunications equipment capable of transmitting and receiving data via the E band, and disposing the equipment on a plurality of aircraft, include payment to the airline industry to dispose the equipment on the aircraft.

20. A method of development of an ultra broadband wireless system for transmitting and receiving data, the system enabling full duplex communication of up to 12.9 GHz bandwidth link radius of 10-500 miles at altitude of 15,000 feet or more, wherein the method comprises:
licensing proprietary systems and methods related to the ultra broadband wireless system; and obtaining permission from the appropriate regulatory agency to steerably transmit data via E-band at altitude of up to and including the earth's stratosphere, and to transmit lower frequency spectrum data from mobile airborne platforms to either other mobile platforms or to fixed terrestrial devices.
